(19) United States
(12) Patent Application Publication
(10) Pub. No.: US 2025/0361408 A1
(43) Pub. Date: Nov. 27, 2025

(54) COATING SYSTEM AND COATED ARTICLE

(71) Applicant: Sherwin-Williams (Guangdong) New Material Co., Ltd., Foshan City (CN)

(72) Inventors: Guijun Fan, Foshan City (CN); Zhenlin Lu, Foshan City (CN)

(21) Appl. No.: 19/215,477

(22) Filed: May 22, 2025

(30) Foreign Application Priority Data
May 27, 2024 (CN) 202410667443.X

(51) Int. Cl. C09D 5/28; C09D 7/40; C09D 7/61; C09D 7/63; C09D 133/04; C09D 175/14

(52) U.S. Cl. CPC C09D 5/28; C09D 7/61; C09D 7/63; C09D 7/68; C09D 7/69; C09D 133/04; C09D 175/14

(57) ABSTRACT

The present application relates to a coating system and a coated article. The coating system has a cracked structure and comprises: (a) a first coating formed by a first coating composition, the first coating composition being a one-component aqueous coating composition and comprising an aqueous dispersion of an aliphatic polyurethane resin and optionally additives; (b) a second coating formed by a second coating composition at least partially applied to the first coating, the second coating composition being a one-component aqueous coating composition and comprising an aqueous dispersion of at least one acrylic resin, silica micropowder, a coalescent and optionally other additives; wherein the aliphatic polyurethane resin has a film forming temperature of 0±10° C. according to ISO 2115:1996 and a film formed from the aliphatic polyurethane resin has an elongation at break according to JG/T 172-2005 in the range of 500-750%; and wherein at least one acrylic resin has a film forming temperature of 80±10° C. according to ISO 2115:1996. The present application further relates a coated article comprising the coating system.

### TECHNICAL FIELD

The present application relates to the field of coatings, in particular to the field of decorative coatings. More specifically, the present application relates to a coating system and a coated article comprising the same.

### BACKGROUND

In the coating industry, coatings formed from coating compositions have a protective and decorative effect on the target substrate being coated. Crackle paint, as a decorative coating, is capable of forming staggered cracks on the substrate. Currently, most crackle paints on the market are organic solvent-based, requiring a large amount of organic solvents during use, which poses significant environmental pollution and harm to human health. Therefore, due to its safety and environmental friendliness, water-based crackle paint is a product of great interest currently.

However, the crackle effect obtained from existing traditional water-based crackle paints resembles tree bark, with irregular crack patterns and many fine lines around, which is not aesthetically pleasing. Additionally, the coating film is generally too soft, unable to produce the crack pattern effect similar to that of porcelain.

Considering the mechanical performance and aesthetic requirements of crackle paint, the coating industry still needs an improved coating system with a cracked structure.

### SUMMARY

A first aspect of the present application provides a coating system having a cracked structure comprising:
(a) a first coating formed by a first coating composition, the first coating composition being a one-component aqueous coating composition and comprising an aqueous dispersion of an aliphatic polyurethane resin and optionally additives;
(b) a second coating formed by a second coating composition at least partially applied to the first coating, the second coating composition being a one-component aqueous coating composition and comprising an aqueous dispersion of at least one acrylic resin, silica micropowder, a coalescent and optionally other additives;
wherein the aliphatic polyurethane resin has a film forming temperature of 0±10° C. according to ISO 2115:1996 and a film formed from the aliphatic polyurethane resin has an elongation at break according to JG/T 172-2005 in the range of 500-750%; and
wherein the at least one acrylic resin has a film forming temperature of 80±10° C. according to ISO 2115:1996.

A second aspect of the present application provides a coating article comprising: a substrate; and the coating system according to the present application applied directly on the substrate.

It has been surprising to find that by skillfully designing the plurality of coatings so that the individual coatings cooperate with each other, it is possible to obtain a coating system that has both a porcelain crackle effect and an excellent combination of properties with good adhesion to the substrate. Preferably, one or more of the advantages of an appearance that meets aesthetic performance requirements, high hardness, and environmental friendliness can be obtained by the embodiments described herein.

The resins, coating compositions, coating systems and coated articles described herein are particularly suitable for use in upholstery or wood furniture.

The details of one or more embodiments of the disclosure are set forth in the following description. Other features, objects, and advantages of the disclosure will be apparent from the description and from the claims.

### DETAILED DESCRIPTION

### Definitions

As used herein, “a”, “an”, “the”, “at least one”, and “one or more” are used interchangeably. Thus, for example, a coating composition that comprises “an” additive can be interpreted to mean that the coating composition includes “one or more” additives. As used herein, the singular forms are intended to include the plural forms as well, unless the context clearly indicates otherwise.

Unless otherwise expressly stated, the terms “comprises,” “having,” “including,” “containing”, “incorporating,” and variations thereof should generally be construed to be open-ended and non-limiting. For example, where a composition is described as comprising, including, containing, or having certain components, it is intended that the composition may include other optional components than the recited components expressly listed, and that the composition may consist of or be composed of the recited components; when a method is described as comprising, including, containing, or having certain steps, it is intended that the method may include other optional steps than the recited steps expressly listed, and that the method may consist of or be composed of the recited steps.

For the sake of brevity, only some numerical ranges are explicitly disclosed herein. However, any lower limit may be combined with any upper limit to form a range that is not explicitly described; and any lower limit may be combined with other lower limit to form an unspecified range; and any upper limit may be combined with any other upper limit to form an unspecified range. Further, although not explicitly specified, each point or single value between the endpoints of a range is included in the range. Thus, each point or single value can be combined with any other point or single value or combined with other lower or upper limits to form a range that is not explicitly specified.

Unless otherwise indicated, each point and single values between endpoints of a range are included in the range. For example, a range from 1 to 5 includes 1, 1.5, 2, 2.75, 3, 3.80, 4, 5, and so on. Further, disclosure of a numerical range includes disclosure of all subranges included within the broader range. For example, a range of from 1 to 5 discloses the subranges of from 1 to 4, from 1.5 to 4.5, from 1 to 2, and so on. Thus, every point or individual value may serve as a lower or upper limit and be combined with any other point or individual value or any other lower or upper limit, and the resulting ranges should be regarded as the contents that are explicitly disclosed in present application.

As used herein, the term “or” is inclusive. That is, the phrase “A or B” means “A, B, or both A and B.” More specifically, any of the following conditions satisfy the condition “A or B”: A is true (or exists) and B is false (or does not exist); A is false (or does not exist) and B is true (or exists); or both A and B are true (or exist). In contrast, the exclusive “or” is expressed herein by the terms such as “either A or B” and “one of A or B.”

When used in the context of “a coating applied on a surface or substrate,” the term “on” includes coatings that are at least partially applied directly or indirectly on the surface or substrate. Thus, for example, a coating applied on at least one primer coating on a substrate is regarded as a coating applied on the substrate.

When used in the context of a coating, the term “elongation at break” means the percentage increase in the length of the coating when a sample of the coating is broken during a tensile break test. In the field of coatings, the standard for elastomeric architectural coatings JG/T 172-2005 specifies a method for determining the elongation at break of a coating.

As used herein, the term “hydroxyl-functional” means containing at least one unreacted hydroxyl functional group.

In the present application, the prefixes of the coating compositions, such as “first,” “second,” “third,” “fourth” and “fifth,” do not have any limiting meaning and are used only for the purpose of differentiation.

The terms “preferred” and “preferably” and any other variation thereof refer to embodiments of the present application that may provide certain advantages under certain circumstances. Under the same or other circumstances, however, other embodiments may be preferred. Additionally, the recitation of one or more preferred embodiments does not indicate that other embodiments are not useful, and is not intended to exclude other embodiments from the scope of the present application.

### DESCRIPTION OF DRAWINGS

FIG. 1 schematically illustrates the coating system formed by the first coating composition and the second coating composition according to the present application.

FIG. 2 schematically illustrates, from left to right, two coating systems formed by a two-component aqueous coating composition (primer coat) and a one-component aqueous coating composition (top coat) in the prior art, respectively, wherein the base coat in the left diagram is white and the top coat is black, and wherein the base coat in the right diagram is black and the top coat is white.

### DETAILED DESCRIPTION

### Coating System

The coating system having a cracked structure according to a first aspect of the present application, comprises: (a) a first coating (also referred to as a “primer coat” in some embodiments) formed by a first coating composition, the first coating composition being a one-component aqueous coating composition and comprising an aqueous dispersion of an aliphatic polyurethane resin and optionally additives; (b) a second coating (also referred to as a “top coat” in some embodiments) formed by a second coating composition at least partially applied to the first coating, the second coating composition being a one-component aqueous coating composition and comprising an aqueous dispersion of at least one acrylic resin, silica micropowder, a coalescent and optionally other additives; wherein the aliphatic polyurethane resin has a film forming temperature of 0±10° C. according to ISO 2115:1996 and a film formed from the aliphatic polyurethane resin has an elongation at break according to JG/T 172-2005 in the range of 500-750%; and wherein the at least one acrylic resin has a film forming temperature of 80±10° C. according to ISO 2115:1996.

By employing a coating system comprising two or more (e.g., three or four) coatings and controlling the film-forming resin in each layer, the coating system can be made to have excellent chemical resistance, high hardness, environmental friendliness, etc., as well as good adhesion to the substrate, and also provide an appearance that meets aesthetic performance requirements, such as a porcelain crackle effect.

In some embodiments, the first one-component aqueous coating composition further comprises an aqueous dispersion comprising hydroxyacrylic polymer particles, and the hydroxyacrylic polymer particles have a particle size in the range of 50 nm to 150 nm, preferably in the range of 70 nm to 120 nm.

By combining an aqueous dispersion of an aliphatic polyurethane resin having a specific elongation at break and a specific minimum film-forming temperature with a certain amount of an aqueous dispersion containing fine particles of hydroxyacrylic polymers in the first one-component aqueous coating composition, it is possible to achieve a better flexibility of the first coating, a better adhesion to the substrate and a crack that will be more homogeneous and closer to a porcelain crackle effect.

A higher amount of hydroxyl groups is beneficial for forming a network structure with small spatial pores between the film-forming resins, which also helps to improve the coating film properties. However, an excessive amount of hydroxyl groups can lead to reduced adhesion to the substrate. Preferably, the content of hydroxyl groups in the aqueous dispersion containing the hydroxyacrylic polymer particles does not exceed 3 wt %, preferably does not exceed 2.5 wt %, more preferably does not exceed 2.3 wt %.

The aqueous dispersion containing fine particles of hydroxyacrylic polymer is commercially available or is formed by polymerization of a monomer mixture, the monomer mixture comprising:
a) hydroxyl C1-C20 alkyl (meth) acrylates;
b) ethylenically unsaturated, acid-functional monomers; and
c) ethylenically unsaturated monomers different from a) and b).

Examples of suitable hydroxyl C1-C20 alkyl (meth) acrylates include, but are not limited to, hydroxyethyl methacrylate, hydroxypropyl methacrylate, hydroxybutyl methacrylate, hydroxyethyl acrylate, hydroxypropyl acrylate, hydroxybutyl acrylate or any combination thereof. Preferably, the hydroxyl C1-C20 alkyl (meth) acrylate is selected from at least one of hydroxyethyl methacrylate, hydroxypropyl methacrylate and hydroxybutyl methacrylate. More preferably, the hydroxyl C1-C20 alkyl (meth) acrylate is selected from hydroxyethyl methacrylate.

Examples of suitable ethylenically unsaturated, acid-functional monomers include, but are not limited to, phosphate-functional, phosphonate-functional, sulfonate-functional, or carboxylic acid-functional monomers or any combinations thereof. Preferably, the ethylenically unsaturated, acid-functional monomer is selected from at least one of phosphate-functional or carboxylic acid-functional monomers, and more preferably at least one of carboxylic acid-functional monomers such as at least one of acrylic acid, methacrylic acid, B-carboxyethyl acrylate, crotonic acid, fumaric acid, maleic anhydride, itaconic acid, or a monoalkyl ester of dibasic acid or acid anhydride (e.g., a monoalkyl ester of maleic acid). Particular preference is given to acrylic or methacrylic acid, and acrylic acid is most particularly preferred.

In addition, the monomer mixture comprises other ethylenically unsaturated monomers different from the above-described hydroxyl C1-C20 alkyl (meth) acrylate and ethylenically unsaturated, acid-functional monomers. Suitable examples of ethylenically unsaturated monomers different from a) and b) include, but are not limited to, C1-C20 alkyl (meth) acrylates and vinyl aromatic compounds having up to 20 carbon atoms.

Examples of C1-C20 alkyl methacrylates suitable the present application include, but are not limited to, methyl methacrylate, ethyl methacrylate, propyl methacrylate, isopropyl methacrylate, n-butyl methacrylate, sec-butyl methacrylate, tert-butyl methacrylate, pentyl methacrylate, hexyl methacrylate, heptyl methacrylate, octyl methacrylate, 2-octyl methacrylate, 2-ethylhexyl methacrylate (also referred to as iso-octyl methacrylate), nonyl methacrylate, 2-methyloctyl methacrylate, 2-tert-butylheptyl methacrylate, 3-isopropylheptyl methacrylate, decyl methacrylate, undecyl methacrylate, 5-methylundecyl methacrylate, dodecyl methacrylate, 2-methyldodecyl methacrylate, tridecyl methacrylate, 5-methyltridecyl methacrylate, tetradecyl methacrylate, pentadecyl methacrylate, hexadecyl methacrylate, 2-methylhexadecyl methacrylate, heptadecyl methacrylate, 5-isopropylheptadecyl methacrylate, 5-ethyloctadecyl methacrylate, octadecyl methacrylate, nonadecyl methacrylate, eicosyl methacrylate, cycloalkyl methacrylates (such as, for example, cyclopentyl methacrylate, cyclohexyl methacrylate, 3-vinyl-2-butylcyclohexyl methacrylate, cycloheptyl methacrylate, cyclooctyl methacrylate), bornyl methacrylate, and isobornyl methacrylate. Preference is given to methyl methacrylate, ethyl methacrylate, butyl methacrylate, tert-butyl methacrylate, or isobornyl methacrylate and particular preference is given to methyl methacrylate or isobornyl methacrylate.

Examples of C1-C20 alkyl acrylates suitable for the present application include, but are not limited to, methyl acrylate, ethyl acrylate, propyl acrylate, isopropyl acrylate, n-butyl acrylate, sec-butyl acrylate, tert-butyl acrylate, pentyl acrylate, hexyl acrylate, heptyl acrylate, octyl acrylate, 2-octyl acrylate, 2-ethylhexyl acrylate (also referred to as iso-octyl acrylate), nonyl acrylate, 2-methyl-octyl acrylate, 2-tert-butylheptyl acrylate, 3-isopropylheptyl acrylate, decyl acrylate, undecyl acrylate, 5-methylundecyl acrylate, dodecyl acrylate, 2-methyldodecyl acrylate, tridecyl acrylate, 5-methyltridecyl acrylate, tetradecyl acrylate, pentadecyl acrylate, hexadecyl acrylate, 2-methylhexadecyl acrylate, heptadecyl acrylate, 5-isopropylheptadecyl acrylate, 5-ethyloctadecyl acrylate, octadecyl acrylate, nonadecyl acrylate, eicosyl acrylate, cycloalkyl acrylates (such as, for example, cyclopentyl acrylate, cyclohexyl acrylate, 3-vinyl-2-butylcyclohexyl acrylate, cycloheptyl acrylate, cyclooctyl acrylate), bornyl acrylate, and isobornyl acrylate. Preference is given to ethyl acrylate, n-butyl acrylate, ethylhexyl acrylate, or cyclohexyl acrylate, and particular preference is given to ethyl acrylate, n-butyl acrylate, or ethylhexyl acrylate.

Suitable vinyl aromatic compounds having up to 20 carbon atoms include, but are not limited to, styrene, vinyltoluene, o- and p-methylstyrene, α-butylstyrene, 4-n-butylstyrene, 4-n-decylstyrene, halogenated styrenes, such as, for example, monochlorostyrenes, dichlorostyrenes, tribromostyrenes or tetrabromostyrenes. Styrene is preferred.

In some embodiments, the amount of the aqueous dispersion containing the hydroxyacrylic polymer fine particles is from 10 wt % to 50 wt %, preferably from 15 wt % to 45 wt %, based on the total weight of the first one-component aqueous coating composition. For example, based on the total weight of the first one-component aqueous coating composition, the amount of the aqueous dispersion containing the hydroxyacrylic polymer fine particles is about 15 wt %, 20 wt %, 25 wt %, 30 wt %, 35 wt %, 40 wt %, or 45 wt %.

In some embodiments, the aqueous dispersion of aliphatic polyurethane resin has a viscosity in the range of 10-250 mPas, preferably in the range of 20-210 mPas, and a solid content in the range of 35-45%, preferably in the range of 36-43%. Such a solid content is favorable for obtaining an environmentally friendly coating with low VOC. Excessive solid content usually leads to higher resin viscosity, which is detrimental to the stability of the coating system and unfavorable for construction. Viscosity may be measured by a rotational viscometer according to ISO 25555:2018.

The aqueous dispersion of aliphatic polyurethane resin can be produced according to a known process, as described in U.S. Pat. No. 4,335,029 or is commercially available.

Preferably, the aqueous dispersion of aliphatic polyurethane resin is an aqueous dispersion of an aliphatic polyester-polyurethane resin. Typically, the NCO-terminated prepolymer is first prepared by reacting a difunctional alcohol with a diisocyanate. Technically, polyester and/or polyether diols and/or polyester/polyether diols are mainly suitable as difunctional alcohols. Polyurethanes are then obtained by chain extension (e.g., with diamines). Self-emulsifying polyurethane dispersions in water can be obtained by adding hydrophilic groups to the molecule, such as anionic carboxylic acid groups or sulfonic acid groups or cationic groups.

Polyester polyols can be used in blends or in combination with polyether polyols or mixtures of polyester polyols and polyether polyols or hybrid polyols based on polyesters and polyethers.

Depending on the composition of the polyol, the number average molecular weight thereof is preferably between 400 and 3000, the number average molecular weight of pure polyether polyols is preferably between 1000 and 2000, and the number average molecular weight of polyester polyols is preferably between 1000 and 3000. The number average molecular weight (Mn) may be measured by NMR or GPC referencing ASTM D5296. The same molecular weight range also applies to hybrid polyether/polyester polyols. Such polyester and polyether polyols are known by various trade names, e.g., the polyether polyol is a propoxylated product of neopentyl glycol or the like, e.g., the polyether polyol. If polyester polyols are mentioned in the text, they include polycarboxylate polyols and polycarbonate polyols.

In some embodiments, the amount of the aqueous dispersion of aliphatic polyurethane resin is from 30 wt % to 85 wt %, preferably from 35 wt % to 80 wt %, based on the total weight of the first one-component aqueous coating composition. For example, based on the total weight of the first one-component aqueous coating composition, the amount of the aqueous dispersion of aliphatic polyurethane resin is about 35 wt %, 40 wt %, 45 wt %, 50 wt %, 55 wt %, 60 wt %, 65 wt %, 70 wt %, 75 wt % or 80 wt %.

If desired, the first one-component aqueous coating composition may optionally include additional additives that do not adversely affect the coating composition or a resultant coating obtained therefrom. Suitable additives include, for example, those that improve the processability or manufacturability of the composition, enhance composition aesthetics, or improve a particular functional property or characteristic of the coating composition or the cured composition resulting therefrom, such as adhesion to a substrate. Additives that may be included are, for example, pigments, metal powders or pastes, anti-migration aids, anti-microbials, extenders, curing agents, lubricants, biocides, plasticizers, rheology modifiers, water-repellent agents, crosslinking agents, antifoaming agents, colorants, waxes, anti-oxidants, anticorrosion agents, flow control agents, thixotropic agents, dispersants, adhesion promoters, UV stabilizers, scavenger agents, thickeners, water retention agents, defoamers, pH adjusters, coalescents (film forming aids), antifreeze agents, slip agents, water-reducing agents, solvents, or combinations thereof. Each optional ingredient can be included in a sufficient amount to serve its intended purpose, but preferably not in such an amount to adversely affect a coating composition or a cured coating resulting therefrom. In a preferred embodiment, the first one-component coating composition may comprise thickeners, defoamers, wetting agents, coalescents, dispersants, fungicides, an aqueous medium, or any combination thereof as the additional additives. In addition, the amount of these additives can be determined by those skilled in the art as needed.

The term “aqueous medium” as used herein refers to water and various solvents miscible with water, including, but not limited to, water, alcohol solvents, ketone solvents, amide solvents, and the like, for example, water; methanol, ethanol, propanol, butanol; acetone, butanone, methylethyl ketone; dimethylformamide, dimethylacetamide, and combinations thereof. Preferably, the aqueous medium is water. In order to accelerate the drying of the coating compositions, mixtures of water and solvents miscible with water, such as combinations of water and ethanol, water and acetone, and the like, may be used. The person skilled in the art can determine the composition of the above solvent mixtures as well as the proportions by simple experimentation to obtain the appropriate drying speed of the coating composition.

If desired, the one-component aqueous coating compositions according to the present application may optionally comprise one or more fillers. The term “filler” as used herein refers to any volume extender suitable for the coating, which may be in organic or inorganic form such as particles. There is no particular restriction on the shape of the particles, which may have any suitable shape. The average particle size of the filler can vary over a wide range, for example from about 10 nm to about 50 μm. Some filler impart one or more desired properties to the composition and/or the coating formed from the composition in addition to acting as a volume extender for the coating. For example, some filler may impart a desired color to the composition and to the coating obtained from the composition. In this case, the pigment/filler may also be referred to as a “pigment”. Some fillers can improve chemical and/or physical properties, in particular mechanical properties of the coating obtained from the composition. In this case, such fillers are also referred to as “reinforcing fillers”.

Suitable exemplary fillers include, for example, kaolin, diatomaceous earth, titanium oxide, calcium carbonate, talc, barium sulfate, magnesium aluminum silicate, silicon oxide (quartz sand) and any combination thereof.

In some embodiments of the present application, the first one-component aqueous coating composition comprises, relative to the total weight of the first one-component aqueous coating composition,
a) 35-80 wt % of the aqueous dispersion of the aliphatic polyurethane resin;
b) 15-45 wt % of the aqueous dispersion containing hydroxyacrylic polymer particles; and
c) 0-30 wt % of additives comprising aqueous media, defoamers, thickeners, wetting agents, dispersants, coalescents, fungicide, fillers, or any combination thereof.

During film formation of an aqueous coating composition, polymer particles in an aqueous dispersion come together as water evaporates from the coating composition to form a coating. The present application utilizes a first one-component aqueous coating composition comprising an aqueous aliphatic polyurethane resin having a specific minimum film-forming temperature (relatively low) as a film-forming resin, paired with a second one-component aqueous coating composition comprising at least one acrylic resin comprising a specific minimum film-forming temperature (relatively high) as a film-forming resin and a silica micropowder, to create a uniform porcelain crackle effect through a soft base and hard surface. In addition, the first one-component aqueous coating composition further comprises an aqueous dispersion containing fine particles of hydroxyacrylic polymer, which not only greatly improves the interpenetration between the polymers in the film-forming process, but also improves the flexibility of the first coating, resulting in larger and more uniform cracks that more closely resemble a porcelain crackle effect.

The inventors have also found that by further incorporating suitable additives (such as coalescents and fillers), the film-forming properties of the aqueous coating composition and the hardness of the resulting coating are further improved, thereby achieving a uniform porcelain crackle effect.

The second coating of the present application is formed from the second one-component aqueous coating composition. According to the present application, the second one-component aqueous coating composition comprises an aqueous dispersion of at least one acrylic resin (aqueous latex). The term “aqueous latex” as used herein refers to a dispersion of synthetic resin (i.e., polymer) in the form of particles in an aqueous medium. Therefore, in the present application, when referring to polymers, unless otherwise stated, the terms “aqueous latex” and “aqueous dispersion” can be used interchangeably. Suitable emulsion polymerization processes are well known to a person skilled in the art, and generally comprise the steps of dispersing and emulsifying polymerizable monomers into water with the aid of, as appropriate, an emulsifier or a dispersion stabilizer under agitation; and initiating polymerization of the monomers, e.g., by adding an initiator. According to the present application, the polymeric particles can be modified by, for example, incorporating therein some organic functionalities including, but not limited thereto, one or more carboxyl, hydroxyl, amino, isocyanate, sulphonic groups, or the like, whereby the aqueous latex can be obtained with desirable properties such as dispersibility. Therefore, the term “aqueous latex” or “aqueous dispersion” as used herein encompasses a dispersion or latex of unmodified polymeric particles in an aqueous medium and also a dispersion or latex of organo-functional modified polymeric particles in an aqueous medium.

The size of the polymeric particles of the aqueous dispersion or latex may be measured in terms of the z-average particle size which is well known in the art. The z-average particle size can be determined according to the dynamic light scattering method by using, for example, a Malvern ZETASIZER™ 3000HS microscopic particle-size analyzer from Malvern Instruments, Ltd. The polymeric particles of the aqueous dispersion of at least one acrylic resin used for the second one-component aqueous coating composition as disclosed herein have a z-average particle size of at most 200 nm, preferably less than 150 nm, more preferably less than 130 nm, even more preferably less than 125 nm, and furthermore preferably less than 110 nm or less. However, the z-average particle size of the polymeric particles is preferably at least 50 nm, more preferably at least 80 nm or more.

During film formation of the coating composition, the polymer particles in the aqueous latex come together as water evaporates from the coating composition to form a coating. Since the aqueous latex particles in the second one-component aqueous coating composition have an appropriate range of particle sizes, the resulting coating has a certain porosity and has an appropriate cohesive strength. If the particle size of the aqueous latex particles is too large, e.g., greater than 200 nm or greater, the formed coating is not sufficiently dense and has poor cohesive strength, whereas if the particle size of the aqueous latex particles is too small, e.g., less than 50 nm or less, a second coating with cracks may not be formed on the surface of the first coating or may be inadequately formed on the surface of the first coating.

In some embodiments, the aqueous dispersion of at least one acrylic resin has a viscosity according to ISO 25555:2018 in the range of 80-2200 mPas, preferably in the range of 100-2000 mPas, and a solid content in the range of 45-55%.

As described above, the aqueous dispersion of at least one acrylic resin (aqueous latex) can be prepared by a suitable emulsion polymerization method known to those skilled in the art. Alternatively, as an example of an aqueous latex, any suitable commercially available product may be used.

In some embodiments, the amount of the aqueous dispersion of at least one acrylic resin is from 35 wt % to 80 wt %, preferably from 40 wt % to 75 wt %, based on the total weight of the second one-component aqueous coating composition. For example, based on the total weight of the second one-component aqueous coating composition, the amount of the aqueous dispersion of at least one acrylic resin is about 40 wt %, 45 wt %, 50 wt %, 55 wt %, 60 wt %, 65 wt %, or 75 wt %.

According to the present application, the aliphatic polyurethane resin has a film-forming temperature of 0±10° C. according to ISO 2115:1996, while at least one acrylic resin has a film-forming temperature of 80±10° C. according to ISO 2115:1996. It follows that the minimum film-forming temperature of at least one acrylic resin for forming the second coating is higher. Thus, in the present application, the second one-component aqueous coating composition further comprises a film-forming aid (coalescent).

In some embodiments, the film-forming aid comprises an alcohol, an alcohol ester, an alcohol ether, an alcohol ether ester, and any combination thereof, preferably selected from one or more of ethylene glycol, propylene glycol, hexylene glycol, benzyl alcohol, dodecanol ester, ethylene glycol butyl ether, propylene glycol methyl ether, propylene glycol ethyl ether, propylene glycol n-propyl ether, propylene glycol butyl ether, dipropylene glycol methyl ether, dipropylene glycol propyl ether, dipropylene glycol butyl ether, tripropylene glycol n-butyl ether, or hexylene glycol butyl ether acetate, more preferably selected from one or more of dipropylene glycol methyl ether or dipropylene glycol butyl ether.

In a preferred embodiment, the film-forming aids are dipropylene glycol methyl ether and dipropylene glycol butyl ether, and the weight ratio of dipropylene glycol methyl ether to dipropylene glycol butyl ether is in the range of 6:1 to 1:2, preferably in the range of 4:1 to 1:1.5.

Surprisingly, when a weight ratio of dipropylene glycol methyl ether to dipropylene glycol butyl ether in the above range is used, the surface drying speed of the second coating (top coating) can be better controlled, and thus a better porcelain crackle effect can be obtained. If the weight ratio is excessively high, the surface drying speed of the top coating is too slow, resulting in smaller cracks in the coating; if the weight ratio is excessively low, the surface drying speed of the top coating is too fast, resulting in larger cracks in the coating, both of which fail to obtain an aesthetically pleasing and uniform porcelain crackle effect.

The second one-component aqueous coating composition of the present application further comprises silica micropowder and may further comprise one or more other fillers. The other fillers have the same or similar composition as the first one-component aqueous coating composition. Suitable exemplary other fillers may include, for example, kaolin, diatomaceous earth, titanium oxide, calcium carbonate, talc, barium sulfate, magnesium aluminum silicate, silicon oxide, and any combination thereof. In preferred embodiments, the other fillers may include titanium oxide, diatomaceous earth, talc, calcium carbonate, or combinations thereof.

In an embodiment according to the present application, the second one-component aqueous coating composition comprises 2-10 wt % of the silica micropowder, preferably 4-8 wt % of the silica micropowder, relative to the total weight of the second one-component aqueous coating composition. Silica micropowder, as defined within, is a silica powder having a particle size in the range of 0.1 μm to 100 μm determined according to the dynamic light scattering method by using a microscopic particle-size analyzer. In a preferred embodiment, the silica micropowder has a particle size in the range of 0.1 μm to 100 μm, preferably in the range of 0.5 μm to 20 μm. In one embodiment, the silica micropowder has a particle size in the range of 1000-2000 mesh, preferably in the range of in the range of 1200-1700 mesh.

Silica micropowder can increase the hardness of the paint film, mainly because it can control the size of the crack and the depth of the texture and the shape of the texture by adding it with the same thickness of the paint film, so as to make the texture more uniform and clearer, so that the effect of the final coating film is closer to the effect of porcelain crackle of ceramics. The inventors found that by controlling the dosage and particle size of the silica micropowder within the above preferred range, the size of the cracks can be effectively controlled so as to obtain a uniform porcelain crackle effect.

In addition, in the embodiments according to the present application, the second one-component aqueous coating composition may further include additional additives commonly used in aqueous coating compositions, which do not adversely affect the coating composition or the cured coating obtained therefrom. Suitable additives include, for example, those that improve the processability or manufacturability of the composition, enhance composition aesthetics, or improve a particular functional property or characteristic of the coating composition or the cured composition resulting therefrom, such as adhesion to a substrate. Additives that may be included are, for example, carriers, emulsifiers, pigments, anti-migration aids, antibacterial agents, chain extenders, lubricants, wetting agents, biological bactericides, defoamers, colorants, waxes, antioxidants, corrosion inhibitors, flow control agents, thixotropic agents, dispersants, adhesion promoters, UV stabilizers, thickeners, defoamers, pH adjustors, or combinations thereof. The content of each optional ingredient is sufficient to achieve its intended purpose, but preferably, such content does not adversely affect the coating composition or the cured coating obtained therefrom. In a preferred embodiment according to the present application, suitable additional additives include aqueous media, wetting agents, dispersants, fillers, thickeners, defoamers, fungicides, or any combination thereof.

The term “aqueous medium” as used herein refers to water and various solvents miscible with water, including, but not limited to, water, alcohol solvents, ketone solvents, amide solvents, and the like, for example, water; methanol, ethanol, propanol, butanol; acetone, butanone, methylethyl ketone; dimethylformamide, dimethylacetamide, and combinations thereof. Preferably, the aqueous medium is water. In order to accelerate the drying of the coating compositions, mixtures of water and solvents miscible with water, such as combinations of water and ethanol, water and acetone, and the like, may be used. The person skilled in the art can determine the composition of the above solvent mixtures as well as the proportions by simple experimentation to obtain the appropriate drying speed of the coating composition.

According to the present application, the total amount of additional additives can vary within a wide range, for example, from 0 wt % to about 50 wt %, based on the total weight of the composition, preferably from about 10 wt % to about 40 wt %. According to the present application, the amount of additional additives included in the preferred second one-component aqueous coating composition, based on the total weight of the composition, can be at least about 10 wt %, more preferably at least about 15 wt %, even more preferably at least about 20 wt %, and most preferably at least about 25 wt %. According to the present application, the amount of additional additives included in the preferred second one-component aqueous coating composition, based on the total weight of the composition, can be up to about 40 wt %, more preferably up to about 35 wt %, even more preferably up to about 30 wt %, and most preferably up to about 28 wt %.

In the embodiments according to the present application, the second one-component aqueous coating composition comprises, relative to the total weight of the second one-component aqueous coating composition:
a) 40-75 wt % of the aqueous dispersion of at least one acrylic resin;
b) 2-10 wt % of the silica micropowder;
c) 5-20 wt % of the coalescent; and
d) 10-40 wt % of other additives comprising aqueous media, fillers, defoamers, thickeners, wetting agents, dispersants, fungicides, or any combination thereof.

As described above, the present application utilizes a first one-component aqueous coating composition comprising an aqueous aliphatic polyurethane resin having a specific minimum film-forming temperature (relatively low) as a film-forming resin, paired with a second one-component aqueous coating composition comprising at least one acrylic resin comprising a specific minimum film-forming temperature (relatively high) as a film-forming resin and a silica micropowder, to create a uniform porcelain crackle effect through a soft base and hard surface. As a result, the hardness of the first coating formed from the first one-component aqueous coating composition is lower than that of the second coating formed from the second one-component aqueous coating composition.

In some embodiments of the present application, the coating system of the present application may be used in conjunction with a primer coat, in which case the coated article of the present application comprises a substrate, at least one primer layer and a coating system according to the present application.

The primer (also known as the third coating composition) may be either waterborne or oil-based. In the case of a waterborne primer, it can include an aqueous latex, which can have the same or similar composition as the aqueous latexes involved in the aforementioned first or second coating compositions, but it can also be a different aqueous latex.

In an embodiment according to the present application, the aqueous latex for the third coating composition comprises any of a variety of aqueous dispersions of organic silicones, styrene-acrylates, acrylates, organic silicone-modified acrylates, vinyl acetate, vinyl acetate-acrylates, vinyl acetate-ethylene, ethylene-vinyl acetate, vinyl acetate-acrylate-esters of versatic acid (e.g., vinyl neodecanoate VeoVA), or any combination thereof. The aqueous latex for the third coating composition may be produced through a variety of suitable emulsion polymerization processes that will be familiar to a person skilled in the art. Alternatively, as a specific example of the aqueous latex, any of the suitable products commercially available may be used, such as an aqueous latex of acrylates.

According to the present application, the third coating composition may optionally include pigments or dyes to provide color. These pigments or dyes are typically incorporated in the form of colorants (also known as color pastes). In the present application, the term “colorant” or “color paste” refers to a colored concentrate obtained by adding pigments or dyes known in the art to a conventional carrier or medium. In the embodiments of the present application, the colorant is water-based and preferably has low VOC. The colorant typically contains one or more pigments or dyes, wherein, for cost reasons, pigments are generally preferred over dyes. As specific examples of color pastes, any appropriate commercially available product can be used.

In the third coating composition of the present application, the type and amount of color paste can be adjusted according to the desired hue and color. In one embodiment, the amount of color paste in the third coating composition, relative to the total weight of the third coating composition, is in the range of 0.01 to 10 wt %.

According to the present application, the preparation of the third coating composition can be achieved by any appropriate method known to those skilled in the art. For example, the third coating composition can be prepared by mixing deionized water, aqueous latex, optional color paste, and additional additives commonly used in the coating field, and stirring until homogeneous.

As those skilled in the art can easily understand, the third coating composition contains a film-forming amount of aqueous latex. Preferably, the content of the aqueous latex in the third coating composition can be appropriately selected as needed. In one embodiment of the present application, the content of the aqueous latex, relative to the total weight of the third coating composition, is in the range of about 20 wt % to 40 wt %, preferably in the range of about 25 wt % to 35 wt %.

If needed, the third coating composition may optionally include additional additives. The role of these additional additives in the primer is similar to that in the aforementioned first and second coating compositions. In the preferred embodiments, the third coating composition of the present applications may include thickeners, dispersants, defoamers, pH regulators, film-forming aids, organic solvents (e.g., alcohols), fungicides, mildewcides, or any combination thereof as additional additives. In addition, the amount of these additives can be determined by those skilled in the art as needed. Preferably, the content of the additional additives is in the range of about 0.1 wt % to 10 wt %, more preferably in the range of about 1 wt % to 5 wt %, relative to the total weight of the third coating composition.

In other embodiments of the present application, the coating system of the present application can be applied without a primer, directly coated on the main surface of the substrate.

In addition, the coating system of the present application may optionally further comprise a cover layer. The cover layer of the present application is formed from a fourth coating composition and optionally is provided over the second coating of the present application.

As can be readily appreciated by those skilled in the art, the fourth coating composition comprises a film-forming amount of aqueous latex. Preferably, the amount of the aqueous latex in the fourth coating composition of the present application is in the range of about 40 wt % to about 55 wt %, relative to the total weight of the fourth coating composition.

The fourth coating composition of the present application comprises an aqueous medium. The term “aqueous medium” as used herein refers to water and various solvents miscible with water, including, but not limited to, water, alcohol solvents, ketone solvents, amide solvents, and the like, for example, water; methanol, ethanol, propanol, butanol; acetone, butanone, methylethyl ketone; dimethylformamide, dimethylacetamide, and combinations thereof. Preferably, the aqueous solvent is water. In order to speed up the drying of the coating compositions, mixtures of water and solvents miscible with water can be used, such as combinations of water and ethanol, water and acetone, and the like. A person skilled in the art can determine the composition of the above solvent mixtures, as well as the proportions, by simple experimentation to obtain the appropriate drying rate of the coating composition.

If desired, the fourth coating composition of the present application optionally comprises additional additives which do not adversely affect the coating composition or the cured coating obtained therefrom. Suitable additives include, for example, those agents that will improve the processability or manufacturability of the composition, enhance the aesthetics of the composition, or improve a particular functional property or characteristic (such as adhesion to the substrate) of the coating composition or the cured composition obtained therefrom. Additives that may be included are, for example, carriers, emulsifiers, anti-migration aids, antimicrobials, chain extenders, curing agents, lubricants, coagulants, wetting agents, biocides, plasticizers, cross-linking agents, defoamers, colorants, waxes, antioxidants, corrosion inhibitors, flow controllers, thixotropics, dispersants, adhesion promoters, UV stabilizers, scavengers, thickeners, antifoamers, pH adjustors, film forming aids, solvents, or combinations thereof. The amount of each optional ingredient is sufficient to serve its intended purpose, but preferably such an amount will not adversely affect the coating composition or the cured coating obtained therefrom. In a preferred embodiment, the fourth coating composition of the present application may comprise dispersants, defoamers, pH adjustors, film-forming aids, organic solvents (e.g., an alcoholic solvent), fungicides, mildewcides, or any combination thereof, as additional additives.

According to the present application, the total amount of additional additives is from 0 wt % to about 20 wt %, preferably from about 0.1 wt % to about 10 wt %, and more preferably from about 0.1 wt % to about 5 wt %, relative to the total weight of the fourth coating composition.

In the embodiments of the present application, the fourth coating composition comprises, based on the total weight of the fourth coating composition,
40 wt % to 55 wt % of a film-forming resin;
40 wt % to 60 wt % of an aqueous medium; and
0 wt % to 20 wt % of additional additives, wherein the additional additives comprise dispersants, defoamers, pH adjusters, or any combination thereof.

In the present application, a cover layer is provided on top of the second coating, which is transparent and thus does not adversely affect the porcelain crackle underneath it, and the coating system on which the stain-resistant cover layer is provided maintains a high level of aesthetics even after being exposed to external environmental conditions for a long period of time (e.g., for weeks, months, or even years), due to its stain-resistant properties.

The coating compositions of the present application can be applied sequentially by conventional methods known to those skilled in the art. For example, the coating compositions may be applied by means of a spray gun, a roller, a blade, or a brush. In one embodiment of the present application, the first coating composition and the second coating composition forming a coating system having a porcelain crackle effect are applied by a spraying process.

In the present application, the coating compositions may comprise a thickener. Suitable thickeners include cellulose ether thickeners, salt-resistant thickeners, starch ether thickeners, alkali-swelling thickeners, polyurethane thickeners, hydrophobically-modified non-polyurethane thickeners, or any combination thereof. All types of thickeners are commercially available commodities. For example, as an example of a cellulose ether thickener, a methyl hydroxyethyl cellulose ether thickener, or a lignocellulose can be used. As a salt-resistant thickener can be used. As a starch ether thickener can be used. As an alkali-swelling thickener can be used, and as a polyurethane thickener can be used.

In a preferred embodiment, the coating composition, relative to the total weight of the coating composition, comprises from about 0.1 wt % to about 1.5 wt %, preferably from about 0.2 wt % to about 1.4 wt %, of a thickener. Specifically, the coating composition comprises a thickener in an amount from about 0.1 wt %, about 0.2 wt %, about 0.3 wt %, about 0.4 wt %, about 0.5 wt %, about 0.6 wt %, about 0.7 wt %, about 0.8 wt %, or about 0.9 wt %, to about 1.5 wt %, about 1.4 wt %, or about 1.3 wt %, relative to the total weight of the coating composition.

In the present application, the coating composition may comprise a defoamer. Suitable defoamers include organosiloxane defoamers, grease defoamers, polyether defoamers, polyether-modified organosilicone defoamers, or any combination thereof. All types of defoamers are commercially available. An organosiloxane antifoam agent may be used, and a grease antifoam agent may be used.

In a preferred embodiment, the coating composition, relative to the total weight of the coating composition, comprises from about 0.1 wt % to about 2 wt %, preferably from about 0.2 wt % to about 1.5 wt %, of a defoamer. Specifically, the coating composition comprises a defoamer in an amount of from about 0.1 wt %, about 0.2 wt %, about 0.3 wt %, about 0.4 wt %, about 0.5 wt %, about 0.6 wt %, about 0.7 wt %, about 0.8 wt %, or about 0.9 wt %, to about 2 weight %, about 1.5 weight %, or about 1.3 weight %, relative to the total weight of the coating composition.

In the present application, the coating composition may comprise a dispersant. Suitable dispersants may include anionic dispersants, cationic dispersants, nonionic dispersants, amphoteric dispersants, or any combination thereof. All types of dispersants are commercially available. In preferred embodiments, suitable dispersants include polyacrylate dispersants, polymethacrylate dispersants, polycarboxylate dispersants, or any combination thereof. As examples of polyacrylate dispersants, polyacrylate dispersant may be used, or polyacrylate dispersant may be used.

In the present application, the coating composition may comprise a fungicide. Suitable fungicides include quaternary ammonium fungicides, chlorine-containing fungicides, peroxide fungicides, azole fungicides, aldehyde fungicides, or any combination thereof. All types of fungicides are commercially available products. For example, an azole fungicide can be used.

In the present application, the coating compositions may comprise a mildewcide. Suitable mildewcides include phenolic mildewcides, chlorophenolic mildewcides, ester mildewcides, heterocyclic mildewcides, amide mildewcides, organometallic salt mildewcides, inorganic salt mildewcides, or any combination thereof. All types of mildewcides are commercially available products.

The coating system described in the present application can have a thickness that varies over a wide range. In some embodiments, the dry film thickness of the first coating (also referred to as the “base coat”) and/or the second coating (also referred to as the “top coat”) is from 5 to 50 microns, preferably from 10 to 40 microns, for example 15 microns, 20 microns, 25 microns, 30 microns, or 35 microns. In some embodiments, the dry film thickness of the second coating is from 5 to 50 microns, preferably from 15 to 30 microns. In some embodiments, the coating system further includes a third coating and a fourth coating to enhance chemical resistance and mechanical performance. For example, the dry film thickness of the third coating and/or the fourth coating can be from 10 to 35 microns, such as 15 microns, 20 microns, 25 microns, or 30 microns. Preferably, the total dry film thickness of the coating system is from 50 microns to 120 microns, for example 60 microns, 80 microns, 90 microns, or 100 microns.

### Coated Article

A second aspect of the present application provides a coated article comprising a substrate having at least one major surface; and the coating system according to the present application applied on the at least one major surface of the substrate. The coating system of the present application can be applied directly to the substrate.

In some embodiments, the substrate is one or more of wood (wood substrate), glass, ceramic, metal, and plastic, preferably wood.

The wood comprises, such as solid wood, for example hardwood, softwood, plywood; veneer, chipboard, low density fiberboard, medium density fiberboard and high density fiberboard, oriented strand board (OSB), wood laminates, rough cardboard and other substrates of which wood is a significant component, such as metal sheet clad wood substrates, laminated wood flooring, plastic trimmed wood, plastic substrates or wood-plastic composites (WPC); substrates with cellulosic fibers, e.g. cardboard or paper substrates.

As the wood substrate used to manufacture the article of the present application, any suitable wood substrate known in the art can be used. In the present application, the term “wood substrate” refers to any cellulose/lignin material derived from the hard, fibrous structural organization of the stems and roots of trees or other woody plants. Wood includes, for example, hardwood and softwood wood cut directly from trees, and engineered wood composite materials made of wood strips, wood chips, wood fibers, or wood veneers. Examples of wood composite materials include, but are not limited to, plywood, oriented strand board (OSB), medium density fiberboard (MDF), particle board, and the like. As exemplary wood substrates, hardwood, chestnut, eucalyptus, red chestnut, camellia, eucalyptus, Douglas fir, Japanese cedar, American cypress, Japanese red pine, Japanese cypress, water walnut, black walnut, maple, Japan beech, Japanese paulownia, birch, Borneo, magnolia, ash, teak, Xylosma japonicum, Catalpa wood, Dryobalanops spp., fir, oak, and rubber wood.

According to the present application, the substrate has at least one, preferably two major surfaces facing each other.

According to the present application, the articles thus obtained can be used in the following applications, including, but not limited to: household furniture, such as tables, chairs, cabinets, etc.; bedroom and bathroom furniture; office furniture; custom furniture, such as school and children's furniture, hospitals furniture, restaurant and hotel furniture, kitchen cabinets and furniture; panels for interior design; indoor and outdoor windows and doors; indoor and outdoor window and door frames; outdoor and indoor wall panels and wooden floors.

The present disclosure is further described in the following examples that are intended as illustrations only. Unless otherwise noted, all parts, percentages, and ratios reported in the following examples are on a weight basis.

### EXAMPLES

The present disclosure is further described in the following examples that are intended as illustrations only. It is to be understood that the particular examples, materials, amounts, and procedures are to be interpreted broadly in accordance with the scope and spirit of the present application as set forth herein. Unless otherwise noted, all parts, percentages, and ratios reported in the following examples are on a weight basis. Unless otherwise specified, all chemicals are used are commercially available.

### Test Methods

### Adhesion

Coating adhesion was determined according to GB/T 9286-2021. It is usually categorized into grades 1˜5, where 1 represents the optimal adhesion, i.e., the cut edges are completely smooth and there is no flaking in the grid, while 5 is the worst.

### Pencil Hardness

This test was used to measure the hardness of cured coatings. GB/T23999-2009 is used to assess pencil hardness. The data is reported as the pencil hardness of the last successful test performed before the coating broke. So, for example, if the coating does not rupture when tested with a 2H pencil, but ruptures when tested with a 3H pencil, the coating is reported as having a pencil hardness of 2H.

### Elongation at Break

This test was performed in accordance with the provisions in the elastomeric architectural coating standard JG/T 172-2005.

### Crackle Effect

Crackle effect was obtained by comparing the specified ceramic cracks, with the shape and depth of the texture produced by the cracking out of the coating system, and is usually categorized into a scale of 1 to 5, where 5 represents the best effect and 1 is the worst.

### Materials

The ingredients used in the examples are shown in Table 1 below.

TABLE 1

| Ingredients | Description |
|---|---|
| Component A | Comparative aqueous polyurethane |
| | resins with a minimum film |
| | forming temperature of 30° C. |
| | according to ISO 2115:1996 |
| Component B | Aqueous dispersions of aliphatic |
| | polyurethane resins according to |
| | the present application |
| Component C | Comparative film-forming resin |
| Component D | Comparative film-forming resin |
| Component E | Requiring a curing agent and |
| | cannot be used in one-component |
| | coating composition |
| Component F | Comparative film-forming resins |
| | with a minimum film-forming |
| | temperature of 35° C. |
| Component G | Aqueous dispersions according to |
| | the present application comprising |
| | hydroxyacrylic acid polymer |
| | particles |
| Component H | Aqueous dispersions of acrylic |
| | resins according to the present |
| | application |
| Component I | Comparative aqueous acrylic resins |
| | with a minimum film-forming |
| | temperature of 55° C. |
| DPM | Dipropylene glycol methyl ether |
| | (coalescent) |
| DPNB | Dipropylene glycol butyl ether |
| | (coalescent) |
| Component J | Silica Micropowder |

### Experiment (Ex.) 1: Preparation of First One-Component Aqueous Coating Composition

A first one-component aqueous coating composition was obtained by mixing the components according to the components and dosages in Table 2 below.

TABLE 2

| | First coating composition | | | | |
|---|---|---|---|---|---|
| Material | A1 | A2 | A3 | A4 | A5 |
| Component A | 75 | | | | |
| Component B | | 50 | | | 75 |
| Component C | | | 75 | | |
| Component E | | | | 75 | |
| Component G | | 25 | | | |
| Defoamer | 0.3 | 0.3 | 0.3 | 0.3 | 0.3 |
| Thickener | 0.4 | 0.5 | 0.4 | 0.3 | 0.3 |
| Fungicide | 0.1 | 0.1 | 0.1 | 0.1 | 0.1 |
| DPM | | / | 3 | 3 | / |
| Water and other additives | 24.2 | 24.1 | 21.2 | 21.3 | 24.3 |
| Total | 100.0 | 100.0 | 100.0 | 100.0 | 100.0 |

### Experiment (Ex.) 2: Preparation of Second One-Component Aqueous Coating Composition

A second one-component aqueous coating composition was obtained by mixing the components according to the components and dosages in Table 3 below.

TABLE 3

| | Second coating composition | | | | | | | |
|---|---|---|---|---|---|---|---|---|
| Material | B1 | B2 | B3 | B4 | B5 | B6 | B7 | B8 |
| Component H | 65 | | | | 65 | 65 | 65 | 65 |
| Component I | | 65 | | | | | | |
| Component D | | | 65 | | | | | |
| Component F | | | | 65 | | | | |
| Defoamer | 0.1 | 0.1 | 0.1 | 0.1 | 0.1 | 0.1 | 0.1 | 0.1 |
| Thickener | 0.3 | 0.4 | 0.3 | 0.3 | 0.3 | 0.3 | 0.3 | 0.3 |
| Fungicide | 0.1 | 0.1 | 0.1 | 0.1 | 0.1 | 0.1 | 0.1 | 0.1 |
| Component J | 6 | 6 | 6 | 6 | 6 | 6 | 1 | 12 |
| DPNB | 2 | 2 | 2 | 2 | 3 | 2 | 2 | 2 |
| DPM | 6 | 6 | 6 | 6 | 1 | 19 | 6 | 6 |
| Water and | 20.5 | 20.4 | 20.5 | 20.5 | 24.5 | 7.5 | 25.5 | 14.5 |
| other additives | | | | | | | | |
| Total | 100.0 | 100.0 | 100.0 | 100.0 | 100.0 | 100.0 | 100.0 | 100.0 |

### Coating System

The 40 standard test substrates were divided into 8 groups, and 5 first coating compositions were sprayed on each of the 5 substrates in each group with an application amount of about 100-130 g/m² to form the first coating. After drying for about 2 hours, the second coating compositions were sprayed on the first coatings of each of the 8 groups, i.e., the second coating composition B1 was sprayed on the first coatings of the 1^{st} group, the second coating composition B2 was sprayed on the first coatings of the 2^{nd} group, and so on. After drying, the resulting coating system was tested for adhesion, crackle effect, and hardness with the following results:

| | Second coating composition | | | | | | | | | | | | | |
|---|---|---|---|---|---|---|---|---|---|---|---|---|---|---|
| | B1 | | | | | B2 | | | | | B3 | | | |
| | First coating composition | | | | | | | | | | | | | |
| | A1 | A2 | A3 | A4 | A5 | A1 | A2 | A3 | A4 | A5 | A1 | A2 | A3 | A4 |
| Adhesion | 4 | 1 | 3 | 4 | 1 | 4 | 1 | 2 | 3 | 1 | 2 | 2 | 2 | 2 |
| Crackle | 3 | 4.5 | 3 | 2 | 4 | 3 | 3 | 2 | 2 | 3 | 3 | 2 | 3 | 2 |
| effect | | | | | | | | | | | | | | |
| Hardness | HB | H | HB | HB | HB | B | B | B | B | B | B | B | B | B |
| Paint film | no | no | no | no | no | no | no | no | no | no | no | no | no | no |
| effect | abnor- | abnor- | abnor- | abnor- | abnor- | abnor- | abnor- | abnor- | abnor- | abnor- | abnor- | abnor- | abnor- | abnor- |
| | mality | mality | mality | mality | mality | mality | mality | mality | mality | mality | mality | mality | mality | mality |

| | Second coating composition | | | | | | | | | | | | |
|---|---|---|---|---|---|---|---|---|---|---|---|---|---|
| | B3 | B4 | | | | | B5 | | | | | B6 | |
| | First coating composition | | | | | | | | | | | | |
| | A5 | A1 | A2 | A3 | A4 | A5 | A1 | A2 | A3 | A4 | A5 | A1 | A2 |
| Adhesion | 2 | 3 | 1 | 3 | 3 | 2 | 3 | 1 | 3 | 3 | 2 | 3 | 1 |
| Crackle | 3 | 3 | 2 | 3 | 2 | 3 | 3 | 3 | 3 | 3 | 3 | 2 | 4 |
| effect | | | | | | | | | | | | | |
| Hardness | B | B | B | B | B | B | HB | HB | HB | HB | HB | B | B |
| Paint film | no | no | no | no | no | no | no | no | no | no | no | no | no |
| effect | abnor- | abnor- | abnor- | abnor- | abnor- | abnor- | abnor- | abnor- | abnor- | abnor- | abnor- | abnor- | abnor- |
| | mality | mality | mality | mality | mality | mality | mality | mality | mality | mality | mality | mality | mality |

| | Second coating composition | | | | | | | | | | | | |
|---|---|---|---|---|---|---|---|---|---|---|---|---|---|
| | B6 | | | B7 | | | | | B8 | | | | |
| | First coating composition | | | | | | | | | | | | |
| | A3 | A4 | A5 | A1 | A2 | A3 | A4 | A5 | A1 | A2 | A3 | A4 | A5 |
| Adhesion | 3 | 3 | 2 | 3 | 1 | 3 | 3 | 2 | 3 | 1 | 3 | 3 | 2 |
| Crackle | 3.5 | 3 | 3.5 | 3 | 4 | 3 | 3 | 3 | 3 | 4 | 3 | 3.5 | 4 |
| effect | | | | | | | | | | | | | |
| Hardness | B | B | B | HB | HB | HB | HB | HB | HB | HB | HB | HB | HB |
| Paint film | no | no | no | no | no | no | no | no | no | no | no | no | no |
| effect | abnor- | abnor- | abnor- | abnor- | abnor- | abnor- | abnor- | abnor- | abnor- | abnor- | abnor- | abnor- | abnor- |
| | mality | mality | mality | mality | mality | mality | mality | mality | mality | mality | mality | mality | mality |

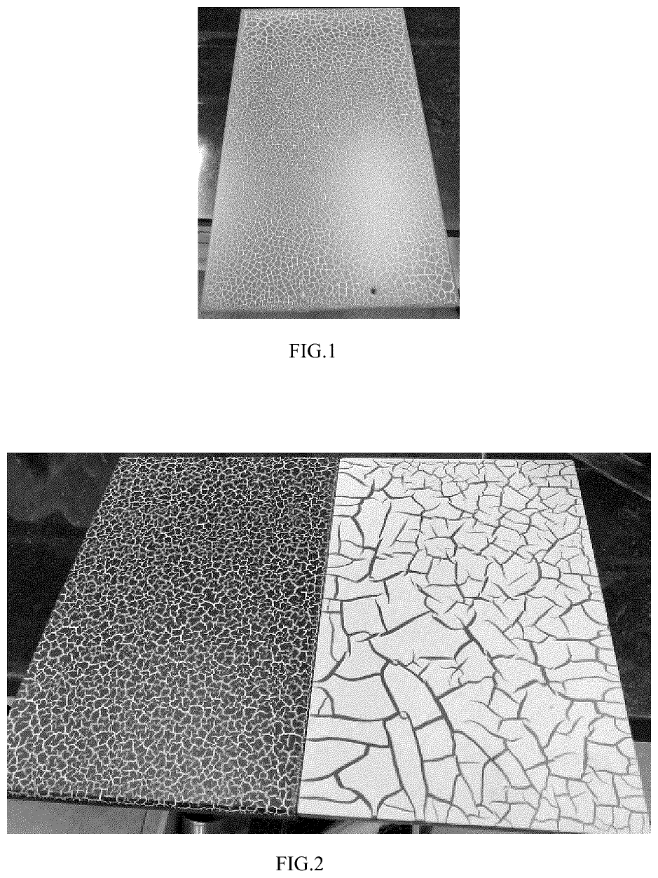

An optional primer layer, the above-mentioned first coating, the second coating and the optional overcoat layer were applied in sequence. The coating system was thus obtained. The present application utilizes an aqueous aliphatic polyurethane resin having a specific minimum film-forming temperature (relatively low) as a film-forming resin of the first one-component aqueous coating composition, together with a second one-component aqueous coating composition comprising at least one acrylic resin with a specific minimum film-forming temperature (relatively high) as a film-forming resin and silica micropowder, to form a uniform porcelain crackle effect by means of a bottom-soft top-hard surface as shown in FIG. 1 attached.

If the first one-component aqueous coating composition further comprises an aqueous dispersion containing hydroxyacrylic polymer particles, and the hydroxyacrylic polymer particles have a particle size in the range from 50 nm to 150 nm, preferably in the range from 70 nm to 120 nm, the first coating is more flexible, has better adhesion to the substrate, and the crack will be more homogeneous and closer to a porcelain crackle effect.

### EMBODIMENTS

Embodiment 1: A coating system having a cracked structure comprising: (a) a first coating formed by a first coating composition, the first coating composition being a one-component aqueous coating composition and comprising an aqueous dispersion of an aliphatic polyurethane resin and optionally additives; (b) a second coating formed by a second coating composition at least partially applied to the first coating, the second coating composition being a one-component aqueous coating composition and comprising an aqueous dispersion of at least one acrylic resin, silica micropowder, a coalescent and optionally other additives; wherein the aliphatic polyurethane resin has a film forming temperature of 0±10° C. according to ISO 2115:1996 and a film formed from the aliphatic polyurethane resin has an elongation at break according to JG/T 172-2005 in the range of 500-750%; and wherein the at least one acrylic resin has a film forming temperature of 80±10° C. according to ISO 2115:1996.

Embodiment 2: An embodiment of Embodiment 1, wherein the first coating composition further comprises an aqueous dispersion containing hydroxyacrylic polymer particles, and wherein the hydroxyacrylic polymer particles have a particle size in the range of 50 nm to 150 nm, preferably in the range of 70 nm to 120 nm.

Embodiment 3: An embodiment of any of Embodiments 1 or 2, wherein the aqueous dispersion of aliphatic polyurethane resin has a viscosity according to ISO 25555:2018 in the range of 10-250 mPas, preferably in the range of 20-210 mPas, and a solid content in the range of 35-45%.

Embodiment 4: An embodiment of any of Embodiments 1 to 3, wherein the coalescent comprises an alcohol, an alcohol ester, an alcohol ether, an alcohol ether ester, and any combination thereof, preferably selected from the group consisting of ethylene glycol, propylene glycol, hexylene glycol, benzyl alcohol, dodecanol ester, ethylene glycol butyl ether, propylene glycol methyl ether, propylene glycol ethyl ether, propylene glycol n-propyl ether, propylene glycol butyl ether, dipropylene glycol methyl ether, dipropylene glycol propyl ether, dipropylene glycol butyl ether, tripropylene glycol n-butyl ether or hexylene glycol butyl ether acetate, more preferably selected from one or more of dipropylene glycol methyl ether or dipropylene glycol butyl ether.

Embodiment 5: An embodiment of any of Embodiments 1 to 4, wherein the aqueous dispersion of at least one acrylic resin has a viscosity according to ISO 25555:2018 in the range of 80-2200 mPas, preferably in the range of 100-2000 mPas, and a solid content in the range of 45-55%.

Embodiment 6: An embodiment of any of Embodiments 1 to 5, wherein the silica micropowder has a particle size in the range of 0.1 μm to 100 μm, preferably in the range of 0.5 μm to 20 μm.

Embodiment 7: An embodiment of Embodiment 4, wherein the coalescent is dipropylene glycol methyl ether and dipropylene glycol butyl ether, and wherein the weight ratio of dipropylene glycol methyl ether and dipropylene glycol butyl ether is in the range of 6:1 to 1:2, preferably in the range of 4:1 to 1:1.5.

Embodiment 8: An embodiment of any of Embodiments 1 to 7, wherein the second coating composition comprises from 2 to 10 wt % of the silica micropowder, preferably from 4 to 8 wt % of the silica micropowder, relative to the total weight of the second coating composition.

Embodiment 9: An embodiment of any of Embodiments 1 to 8, wherein the first coating composition comprises, relative to the total weight of the first coating composition: a) 35-80 wt % of the aqueous dispersion of the aliphatic polyurethane resin; b) 15-45 wt % of the aqueous dispersion containing hydroxyacrylic polymer particles; and c) 0-30 wt % of additives comprising aqueous media, defoamers, thickeners, wetting agents, dispersants, coalescents, fungicides, fillers or any combination thereof.

Embodiment 10: An embodiment of any of Embodiments 1 to 9, wherein the second coating composition comprises, relative to the total weight of the second coating composition: a) 40-75 wt % of the aqueous dispersion of the at least one acrylic resin; b) 2-10 wt % of the silica micropowder; c) 5-20 wt % of the coalescent; and d) 10-40 wt % of other additives comprising aqueous media, fillers, defoamers, thickeners, wetting agents, dispersants, fungicides, or any combination thereof.

Embodiment 11: An embodiment of any of Embodiments 1 to 10, wherein the hardness of the first coating formed by the first coating composition is lower than the hardness of the second coating formed by the second coating composition.

Embodiment 12: An embodiment of any of Embodiments 1 to 11, wherein the weight ratio of the first coating composition to the second coating composition is from 1:1 to 1:2.

Embodiment 13: An article comprising: a substrate having at least one primary surface; and a coating system according to any one of Embodiments 1 to 12 at least partially applied directly or indirectly to the main surface of the substrate.

Embodiment 14: An embodiment of Embodiment 13, wherein the substrate is one or more of wood, glass, ceramic, metal, and plastic, preferably wood.

While the present application has been described with reference to a number of embodiments and examples, those skilled in the art will readily recognize that changes may be made to the present application without departing from the principles disclosed in the foregoing specification. For example, without departing from the principles disclosed in the foregoing specification, the technical solutions obtained by combining multiple features or preferred modes described herein should be understood as belonging to the contents described herein. Such changes are considered to be included in the following claims unless the claims expressly state otherwise. Accordingly, the embodiments detailed herein are exemplary only and are not intended to limit the scope of the present application, which is the full scope of the appended claims and any and all equivalents thereof.

What is claimed is:

1. A coating system having a cracked structure comprising:
(a) a first coating formed by a first coating composition, the first coating composition being a one-component aqueous coating composition and comprising an aqueous dispersion of an aliphatic polyurethane resin and optionally additives;
(b) a second coating formed by a second coating composition at least partially applied to the first coating, the second coating composition being a one-component aqueous coating composition and comprising an aqueous dispersion of at least one acrylic resin, silica micropowder, a coalescent and optionally other additives;
wherein the aliphatic polyurethane resin has a film forming temperature of 0±10° C. according to ISO 2115:1996 and a film formed from the aliphatic polyurethane resin has an elongation at break according to JG/T 172-2005 in the range of 500-750%; and
wherein the at least one acrylic resin has a film forming temperature of 80±10° C. according to ISO 2115:1996.

2. The coating system according to claim 1, wherein the first coating composition further comprises an aqueous dispersion containing hydroxyacrylic polymer particles, and wherein the hydroxyacrylic polymer particles have a particle size in the range of 50 nm to 150 nm, preferably in the range of 70 nm to 120 nm.

3. The coating system according to claim 1, wherein the aqueous dispersion of aliphatic polyurethane resin has a viscosity according to ISO 25555:2018 in the range of 10-250 mPas, preferably in the range of 20-210 mPas, and a solid content in the range of 35-45%.

4. The coating system according to claim 1, wherein the coalescent comprises an alcohol, an alcohol ester, an alcohol ether, an alcohol ether ester, and any combination thereof, preferably selected from the group consisting of ethylene glycol, propylene glycol, hexylene glycol, benzyl alcohol, dodecanol ester, ethylene glycol butyl ether, propylene glycol methyl ether, propylene glycol ethyl ether, propylene glycol n-propyl ether, propylene glycol butyl ether, dipropylene glycol methyl ether, dipropylene glycol propyl ether, dipropylene glycol butyl ether, tripropylene glycol n-butyl ether or hexylene glycol butyl ether acetate, more preferably selected from one or more of dipropylene glycol methyl ether or dipropylene glycol butyl ether.

5. The coating system according to claim 1, wherein the aqueous dispersion of the at least one acrylic resin has a viscosity according to ISO 25555:2018 in the range of 80-2200 mPas, preferably in the range of 100-2000 mPas, and a solid content in the range of 45-55%.

6. The coating system according to claim 1, wherein the silica micropowder has a particle size in the range of 0.1 μm to 100 μm, preferably in the range of 0.5 μm to 20 μm.

7. The coating system according to claim 4, wherein the coalescent is dipropylene glycol methyl ether and dipropylene glycol butyl ether, and wherein the weight ratio of dipropylene glycol methyl ether and dipropylene glycol butyl ether is in the range of 6:1 to 1:2, preferably in the range of 4:1 to 1:1.5.

8. The coating system according to claim 1, wherein the second coating composition comprises from 2 to 10 wt % of the silica micropowder, preferably from 4 to 8 wt % of the silica micropowder, relative to the total weight of the second coating composition.

9. The coating system according to claim 1, wherein the first coating composition comprises, relative to the total weight of the first coating composition
a) 35-80 wt % of the aqueous dispersion of the aliphatic polyurethane resin;
b) 15-45 wt % of the aqueous dispersion containing hydroxyacrylic polymer particles; and
c) 0-30 wt % of additives comprising aqueous media, defoamers, thickeners, wetting agents, dispersants, coalescents, fungicides, fillers, or any combination thereof.

10. The coating system according to claim 1, wherein the second coating composition comprises, relative to the total weight of the second coating composition
a) 40-75 wt % of the aqueous dispersion of the at least one acrylic resin;
b) 2-10 wt % of the silica micropowder;
c) 5-20 wt % of the coalescent; and
d) 10-40 wt % of other additives comprising aqueous media, fillers, defoamers, thickeners, wetting agents, dispersants, fungicides, or any combination thereof.

11. The coating system according to claim 1, wherein the hardness of the first coating formed by the first coating composition is lower than the hardness of the second coating formed by the second coating composition.

12. The coating system according to claim 1, wherein the weight ratio of the first coating composition to the second coating composition is from 1:1 to 1:2.

13. An article comprising:
a substrate having at least one primary surface; and
a coating system according to claim 1 at least partially applied directly or indirectly to the main surface of the substrate.

14. The article according to claim 13, wherein the substrate is one or more of wood, glass, ceramic, metal, and plastic, preferably wood.
